(19) United States
(12) Patent Application Publication
(10) Pub. No.: US 2002/0099660 A1
(43) Pub. Date: Jul. 25, 2002

(54) Method for download of songs from the internet

(76) Inventor: Cheng-Tao Paul Lee, Taipei City (TW)

Correspondence Address: Jason Z. Lin, 19597 Via Monte Drive, Saratoga, CA, 95070, US

(21) Appl. No.: 09/769,989

(22) Filed: Jan. 25, 2001

(51) Int. Cl. G06F 17/60; H04L 9/00; H04K 1/00

(52) U.S. Cl. 705/51; 705/26; 705/27; 705/52

(57) ABSTRACT

A method for download of songs from the Internet is applicable to a system architecture comprising a plurality of client computers, a server computer, and a plurality of song-providing computers. The server computer is applied to receive a song-download and a song-payment instruction from a client computer, and encode the chosen song to include at least a playback limitation and song data before downloading to the client computer for prevention of illegal song-spread.

### FIELD OF THE INVENTION

This invention relates to methods for download of songs from the Internet, particularly to a method for download of songs comprising at least a playback limitation and song data for preventing illegal spread of songs.

### BACKGROUND OF THE INVENTION

As the civil case suing for protection of the intellectual property rights comes one after another like the upstream struggling salmon in the so-called “Information era,” a lawyer in this business may be the one well qualified to yell: “Thanks to the lovely Internet!”

Any one, should he wants to, can enter a browser and hyperlink with any web site desired to download a file, the MP3 music file for example. By doing so, he may or may not have infringed an inventor's intellectual property rights depending on whether the web site is franchised by the MP3 producer or not.

Therefore, an admission condition for download of a playback-software and encoded songs seems a feasible measure to protect the version rights of a song-producer and eliminate abovesaid illegalities.

### SUMMARY OF THE INVENTION

The primary object of this invention is to provide a method for download of songs from the Internet, which is applied to encode a song to cany with a playback limitation so as to prevent songs from being illegally spread for protection of the intellectual property rights.

For realizing abovesaid object, the method of this invention for download of songs from the Internet applicable to a system architecture composed of a plurality of client computers, a server computer, and a plurality of song-providing computers shall comprises the steps below:

(a) Using the server computer to receive a song-download instruction from a client computer through the Internet;

(b) Using the server computer to receive a payment instruction from the client computer for the songs to be downloaded, wherein the payment instruction should comprise at least the admission of a prepayment manner;

(c) Using the server computer to go steps below according to the chosen songs of the song-download instruction after checking of the payment instruction:

(c1) Judging whether the chosen songs are stored in the song-providing computers or in the server computer itself; and

(c2) Accessing the chosen songs basing on the judgment made in the step (c1);

(d) Using the server computer to encode the chosen songs and provide each song with at least a playback limitation and song data;

(e) Using the server computer to download the encoded chosen songs to the client computer;

(f) Using the server computer to download a playback-software to the client computer through the Internet for playback the encoded chosen songs according to the step (d);

(g) Using the server computer to receive a playback-software registry-application from the client computer; and

(h) Using the server computer to download a registry admission basing on the application in the step (g), wherein the registry admission should comprise at least: a serial number and a password, or a member account number and a password.

In the step (c2), suppose the step (c1) judges that the chosen songs are stored in the song-providing computers, then the server computer will access the song-providing computers for the chosen songs through the Internet.

For more detailed information regarding this invention together with advantages or features thereof, at least an example of preferred embodiment will be described below in detail with reference to the annexed drawings.

### BRIEF DESCRIPTION OF THE DRAWINGS

The related drawings in connection with the detailed description of this invention, which is to be made later, are described briefly as follows, in which:

FIG. 1 is a schematic view of a network-architecture applicable to this invention;

FIG. 2 shows a flowchart of this invention;

FIG. 3 shows a flowchart of this invention for obtaining a playback-software legally;

FIG. 4 shows a screen of the playback-software run at the first time on a client computer;

FIG. 5 shows a dialog box of the playback-software of FIG. 4 on the client computer after registration is admitted;

FIG. 6 shows that a server computer is applied in a song-downloading process performed on a client computer;

FIG. 7A is a schematic view of an encoded song of this invention;

FIG. 7B is a first embodiment based on FIG. 7A;

FIG. 7C is a second embodiment based on FIG. 7A;

FIG. 7D is a third embodiment based on FIG. 7A; and

FIG. 8 shows an encoded song of this invention with data of a background movie.

### DETAILED DESCRIPTION OF THE PREFERRED EMBODIMENT

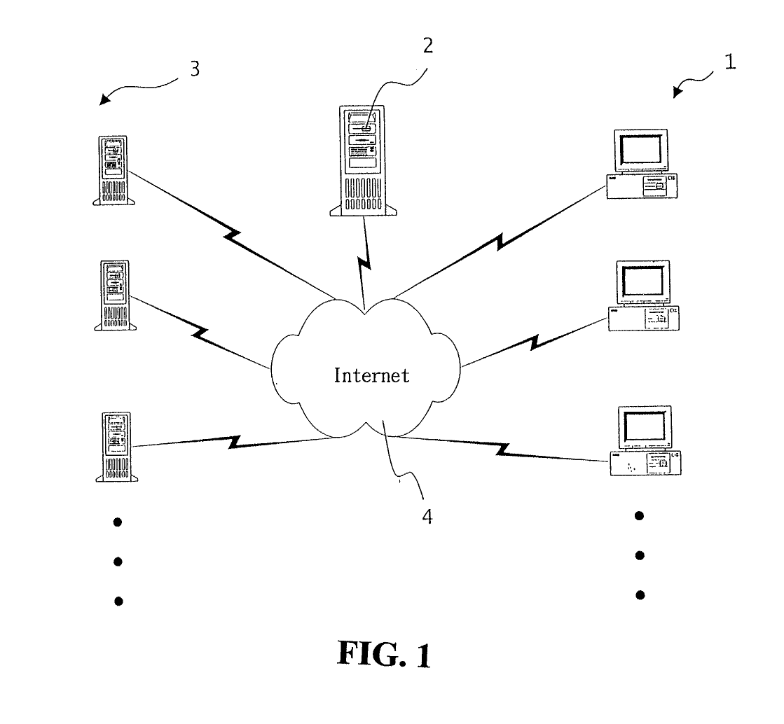

In a system architecture applicable to this invention shown in FIG. 1, the Internet 4 is connected respectively with a server computer 2, a plurality of client computers 1, and a plurality of song-providing computers 3. The client computer 1 is basically a network-connectable electronic machine to be connected with the server computer 2 through the Internet 4. A playback-software stored in the server computer 2 for playback of encoded songs according to this invention is accessible and can be downloaded to the client computer 1. The downloaded playback-software in the client computer 1 must be registered to the server computer 2 for obtaining an admission in order to playback encoded songs based on a method of this invention.

The server computer 2 in FIG. 1 comprises at least:

a song-database having stored a numerosity of song files;

a plurality of processing programs for download of encoded songs, payment of encoded songs, download of playback-software, registration of playback-software, etc when a client computer 1 is linked to the server computer 2;

an encoding program for encoding songs to be downloaded to the online client computer 1 with at least a playback limitation and song data, wherein the playback limitation may be a playback expiry date, playback times termination, or member account only; and

a playback-software for an online client computer to download and playback encoded songs.

Above said encoding program of the server computer 2 can further encode the song with data of a background movie. The mentioned processing programs of the server computer 2 may combine technology of: http homepage, ftp, or remote procedure call for proceeding download or payment of the encoded songs, download of the playback-software, and registration of the playback software, etc.

A song-providing computer 3 in FIG. 1 has stored a numerosity of song files for remote access. For example, the server computer 2 can remotely access the song files in the song-providing computer 3 through the Internet 4.

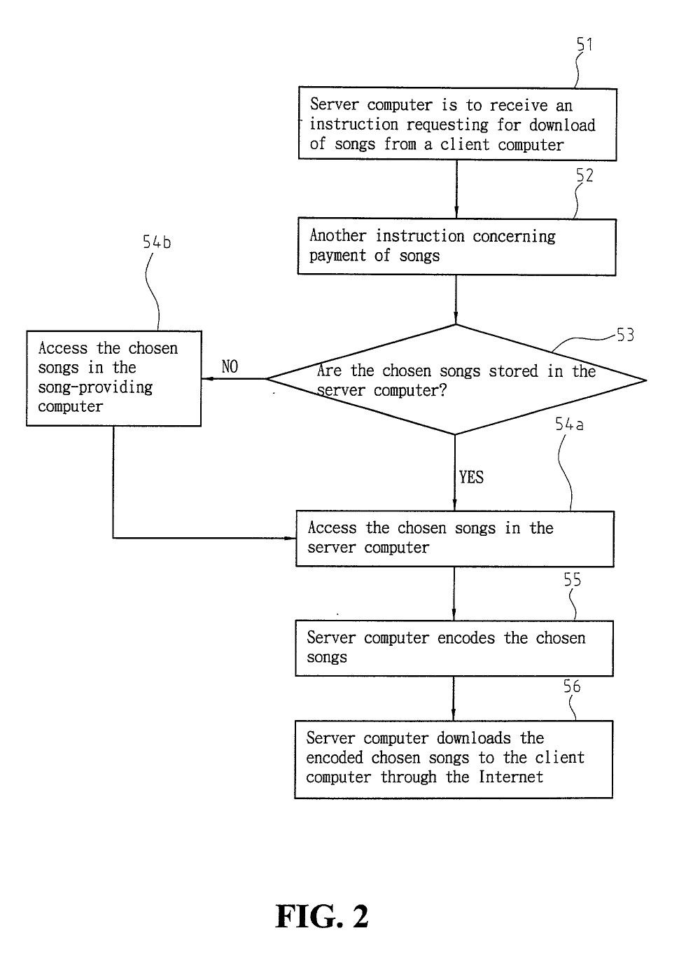

In a flowchart of this invention shown in FIG. 2, the server computer 2 is to receive an instruction requesting for download of songs in step 51 and another instruction for payment of the songs to be downloaded in step 52 from an online client computer 1 through the Internet 4. In step 53, the server computer 2 is to check basing on the payment instruction whether the clicked songs for download are stored in a song-database in the server computer 2 or not. If positive, the server computer 2 goes to step 54a for accessing the selected songs, otherwise, goes to step 54b for accessing the song-providing computer 3. In step 55, the server computer 2 is to encode the selected songs so that every song shall include at least a playback limitation and song data, wherein the playback limitation may be a playback expiry date, playback times termination, or member account only. In step 56, the server computer 2 is to download the encoded songs to the client computer 1 through the Internet 4, further more, those songs can be compressed for shortening download time.

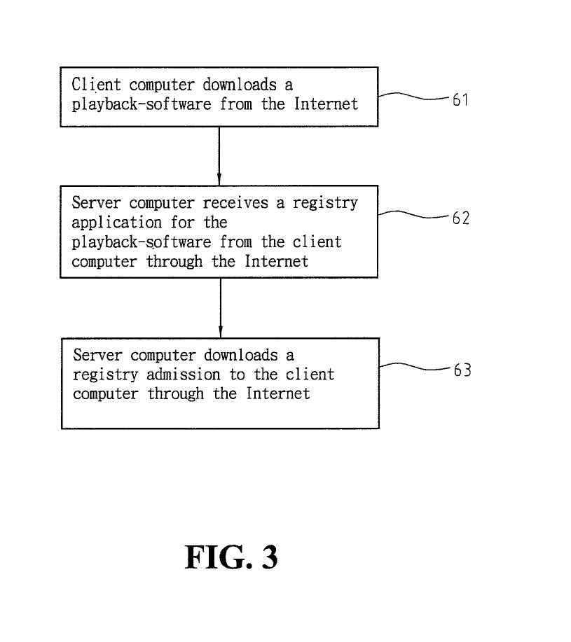

In a flowchart for obtaining playback-software shown in FIG. 3, the server computer 2 provides the playback-software for the client computer 1 to download through the Internet 4 in step 61. In step 62, the client computer 1 is to apply registration of the playback-software to the server computer 2, and in step 63, the server computer 2 is to authenticate and download the playback-software registration data to the client computer 1 through the Internet 4.

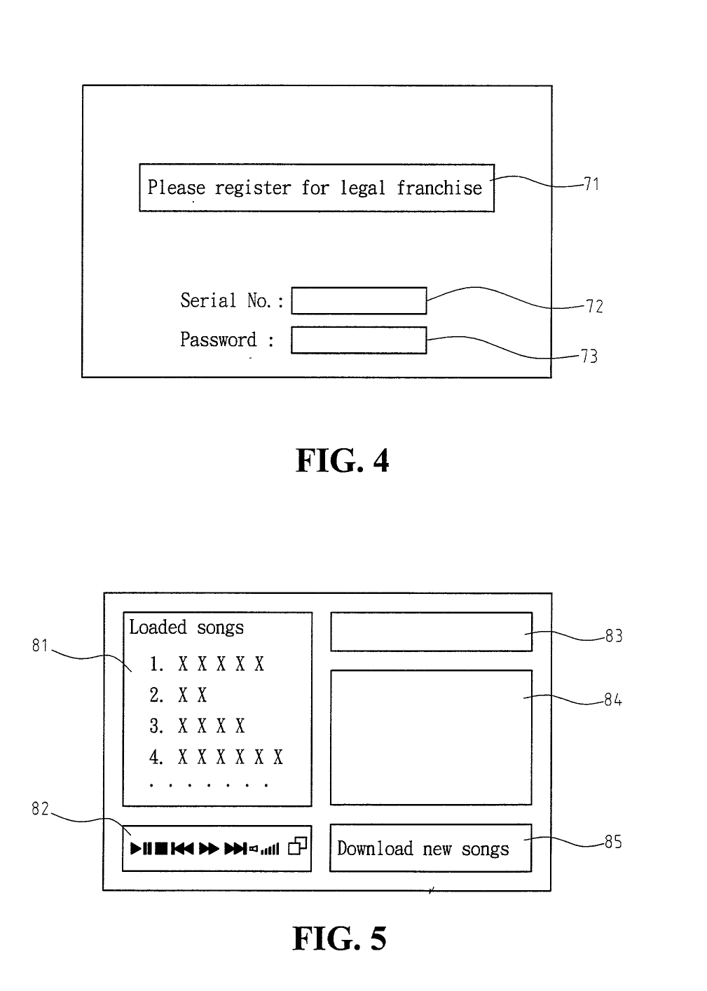

So far, the client computer 1 can link to the server computer 2 and download the playback-software via a communication-software for Internet-connection, such as a browser or the like. FIG. 4 shows the first time the downloaded playback-software executed on the client computer 1, wherein a box 71 shown in the dialog box of the playback-software is clicked by an input device (not shown)—a mouse, for example, to call the communication software to joint with the server computer 2 through the Internet 4 and progress the mentioned steps 62 and 63. A user is supposed now to fill a registered serial number and a password admitted by the server computer 2 in boxes 72 and 73 respectively to thereby complete the registration formality, and the registered playback-software can play any encoded song from now on. The registration data may be made as a member account number or a password in another embodiment formation.

FIG. 5 shows a dialog box of the playback-software of FIG. 4 on a client computer after registration is admitted. Box 81 in FIG. 5 is a block for showing a directory of downloaded songs, and a user may click to choose any of the listed encoded songs for playback. Box 82 indicates a playback key that controls playback of the listed songs. Box 83 is arranged to show status of a chosen song concerning playback limitation by showing up, for example, the remaining playback times, the playback expiry date, playback expiry date overrun, the playback times used up, etc. In the case of playing with a musical accompaniment (kara OK), movie is played in box 84, which may be switched from a partial screen to a full screen by clicking a full-screen control button of a playback control key in box 82. Box 85 is arranged for being clicked to download songs, and when it is clicked, the playback-software will call the communication-software for Internet-connection to the server computer 2.

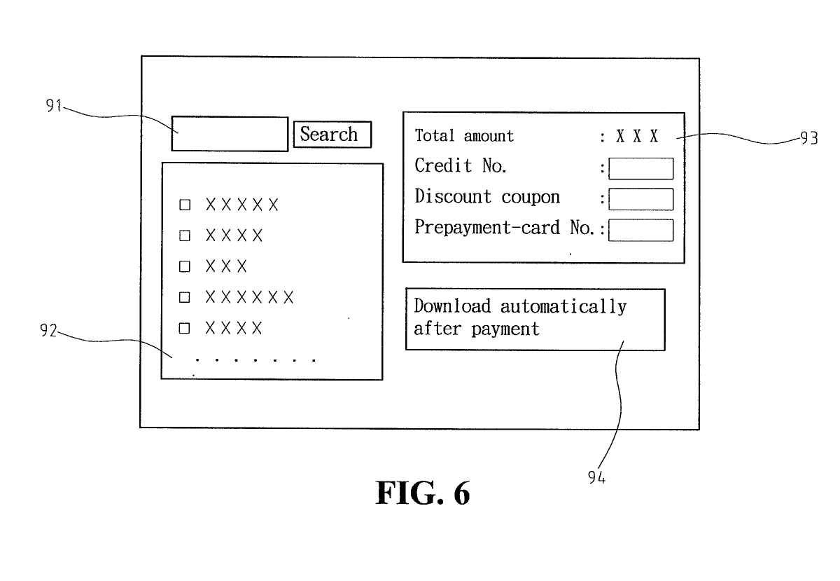

FIG. 6 shows that the server computer 2 is applied in a song-download process performed on a client computer. After selection of songs and way of payment are decided, a user is supposed to click box 94 for transmitting instruction of song-download and payment, namely, to proceed the steps 51 and 52. Box 91 is a box for input of key words, such as name of songs, singers, or composers for searching, and the song list will be shown in box 92 for the client computer 1 to make checks and song-selection. Box 93 shows the total amount of the chosen songs and is arranged for input of number of: a credit card, a discount coupon, or a prepaid card, then the user at the client end is to click box 94 to effect payment. At this moment, the server computer 2 will check the payment and judge whether the chosen songs are stored in the song-providing computer 3 or in the server computer 2 itself so as to access and download the songs to the client computer 1.

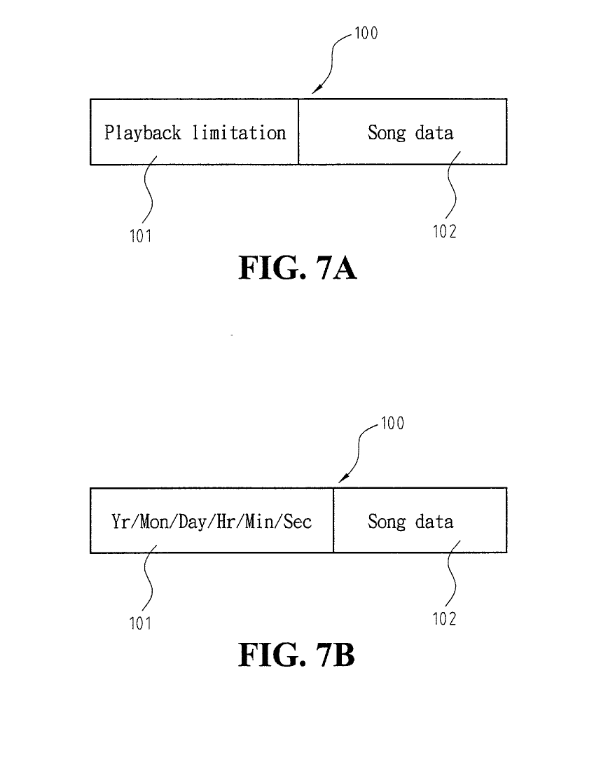

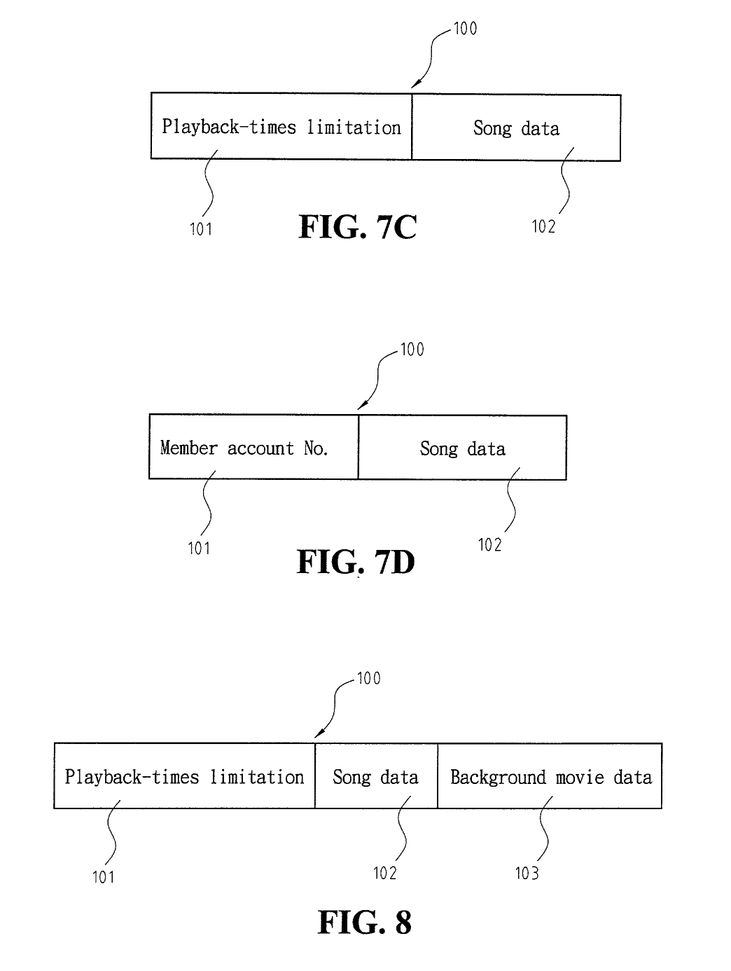

According to a schematic view of encoded song of this invention shown in FIG. 7A, an encoded song 100 should comprise at least a playback limitation 101 and song data 102, wherein the song data 102 are provided by a song-database of the song-providing computer 3 or in the server computer 2; and after the encoding program is executed by the server computer 2, the song data 102 and the playback limitation 101 are combined to become the encoded song 100.

In FIG. 7B—a first embodiment based on FIG. 7A—the playback limitation 101 regulates the deadline of the song data 102 as of “Year/Month/Day/Hr/Min/Sec” while in a second embodiment shown in FIG. 7C, the playback limitation 101 regulates the maximum playback times of the song data 102, and in a third embodiment shown in FIG. 7D, the playback limitation 101 regulates “member only” by input of member account number.

FIG. 8 indicates that the encoded song 100 further comprises a background movie data 103. As the song data 102 of FIG. 8 is usually a song of musical accompaniment, so that the background movie data 103 can be shown in the box 84 of FIG. 5 meanwhile the playback-software of the client computer 1 is playing the encoded song 100.

The playback-software of this invention can further access a storage media of Compact Disk Drive (CDD, not shown) in the client computer 1. Because the storage media has stored a plurality of background movie files, therefore, the playback-software of this invention may access the storage media and pick up a decent background movie for pairing with an encoded song without background movie and displaying in the box 84 of FIG. 5.

In addition to playback of encoded songs, the playback-software of this invention may be integrated with a mentioned communication-software for Internet-connection functioned as a browser or ftp, so that the integrated playback-software may go connecting directly to the server computer 2 via the Internet, choosing and purchasing songs, and obtaining and displaying news of the latest songs.

In the above described, at least one preferred embodiment has been elucidated with reference to the drawings annexed, and it is apparent that numerous variations or modifications may be made without departing from the true spirit and scope thereof, as set forth in the claims below.

What is claimed is:

1. A method for download of songs from the Internet, applicable to a system architecture composed of a plurality of client computers, a server computer, and a plurality of song-providing computers, and comprising the steps of:
(a) Using the server computer to receive a song-download instruction from a client computer through the Internet;
(b) Using the server computer to receive a payment instruction from the client computer for the songs to be downloaded, wherein the payment instruction should comprise at least the admission of a prepayment manner;
(c) Using the server computer to go steps below according to the chosen songs of the song-download instruction after checking of the payment instruction:
(c1) Judging whether the chosen songs are stored in the song-providing computers or in the server computer itself; and
(c2) Accessing the chosen songs basing on the judgment made in the step (c1);
(d) Using the server computer to encode the chosen songs and provide each song with at least a playback limitation and song data; and
(e) Using the server computer to download the encoded chosen songs to the client computer.

2. The method according to claim 1, further comprising the steps of:
(f) Using the server computer to download a playback-software to the client computer through the Internet for playback the encoded chosen songs according to the step (d).

3. The method according to claim 1, wherein the step (d) further comprises the step of: compressing the encoded chosen songs.

4. The method according to claim 1, further comprising the steps of:
(f) Using the server computer to download a playback-software to the client computer through the Internet for playback the encoded chosen songs according to the step (d);
(g) Using the server computer to receive a playback-software registry-application from the client computer; and
(h) Using the server computer to download a registry admission basing on the application in the step (g), wherein the registry admission should comprise at least: a serial number and a password, or a member account number and a password.

5. The method according to claim 1, wherein suppose the step (c1) judges that the chosen songs are stored in the song-providing computers during the step (c2), the server computer will then access the song-providing computers for the chosen songs through the Internet.

6. The method according to claim 1, wherein the playback limitation is a playback-time expiry limitation.

7. The method according to claim 1, wherein the playback limitation is a playback-times limitation.

8. The method according to claim 1, wherein the playback limitation is an identification limitation to admit “member account number” only.

9. The method according to claim 1, wherein the encoded chosen song further comprises data of a background movie.

10. The method according to claim 4, wherein the registry admission should comprise at least: a serial number and a password.

11. The method according to claim 4, wherein the registry admission should comprise at least: a member account number and a password.

12. The method according to claim 1, wherein the prepayment manner is to be made by way of a prepayment card.

13. The method according to claim 1, wherein the payment instruction further comprises a payment manner of credit card.

14. The method according to claim 1, wherein the payment instruction further comprises a payment manner of discount coupon.
